(19) United States
(12) Patent Application Publication
(10) Pub. No.: US 2026/0219772 A1
(43) Pub. Date: Jul. 30, 2026

(54) Method and System to Provide a Viewing and Replay Functionality for Agricultural Data Layers

(71) Applicant: Precision Planting LLC, Tremont, IL (US)

(72) Inventors: Matthew Nelson, Peoria, IL (US); David Aaron Wilcosxon, Tremont, IL (US)

(21) Appl. No.: 19/145,950

(22) PCT Filed: Dec. 21, 2023
(86) PCT No.: PCT/IB2023/063093

§ 371 Date: Jul. 7, 2025

Related U.S. Application Data
(60) Provisional application No. 63/479,593, filed on Jan. 12, 2023.

(51) Int. Cl. G06F 3/04842; G06F 3/04817; G06F 3/04845; G06Q 50/02

(52) U.S. Cl. CPC G06F 3/04842; G06F 3/04817; G06F 3/04845; G06Q 50/02; G06F 2203/04803; G06F 2203/04805; G06F 2203/04806

(57) ABSTRACT

Systems and methods for providing a replay functionality for agricultural data layers in a field view of a graphical user interface of a software application. The method includes receiving a user input for selecting a parameter for an agricultural data layer, generating and displaying the agricultural data layer in the field view based on the user input, receiving, with the graphical user interface of the software application, selection of one or more locations in the field view, and generating and displaying a notification (e.g., intelligent flag to display an associated data value) for each selected location in the field view.

### CROSS REFERENCE TO RELATED APPLICATIONS

This application claims priority to U.S. Provisional Application No. 63/479,593, filed 12 Jan. 2023, which is incorporated herein by reference in it entirety.

### TECHNICAL FIELD

Embodiments of the present disclosure relate to a method and system to provide a viewing and replay functionality for agricultural data layers of field views.

### BACKGROUND

Planters are used for planting seeds of crops (e.g., corn, soybeans) in a field. Some planters include a display monitor within a cab for displaying a coverage map that shows regions of the field that have been planted. The coverage map of the planter is generated based on planting data collected by the planter.

A combine harvester or combine is a machine that harvests crops. A coverage map of a combine displays regions of the field that have been harvested by that combine. A coverage map allows the operator of the combine to know that a region of the field has already been harvested by the same combine. Yield data for a field can then be generated after harvesting the field. The yield data can be analyzed in order to potentially improve agricultural operations for a subsequent growing season.

### BRIEF SUMMARY

In an aspect of the disclosure there is provided a computer implemented method for providing a replay functionality for agricultural data layers in a field view of a graphical user interface (GUI) of a software application. The method includes receiving with the GUI a user input for selecting a parameter for an agricultural data layer, generating and displaying with the GUI the agricultural data layer in the field view based on the user input, receiving, with the GUI of the software application, selection of one or more locations in the field view, and generating and displaying a notification (e.g., intelligent flag to display an associated data value) for each selected location in the field view.

In one example of the computer implemented method, further comprising receiving, with the graphical user interface, user input to initiate a replay functionality for replaying a route of a tractor during an application pass and replaying the agricultural data layer as collected during the application pass.

In one example of the computer implemented method, further comprising generating, with the graphical user interface, a video replay for the field view with a tractor icon moving across the agricultural data layer for the selected parameter based on the user input to initiate replay functionality.

In one example of the computer implemented method, further comprising generating a pop up window or a side by side window to display a data value that is associated with a location of the tractor icon and the data value updates as the tractor icon moves along a route of a tractor during data collection from an application pass.

In one example of the computer implemented method, wherein the pop up window or the side by side window to display one or more data values including a data value for a first parameter and a data value for a second parameter that are associated with the location of the tractor icon.

In one example of the computer implemented method, wherein the pop up window or the side by side window displays diagnostics including force diagnostics for any location in the field or machine sensors readings including voltages, a meter vacuum, a duty cycle, encoder counts, or CAN network statistics from an implement bus.

In one example of the computer implemented method, further comprising collecting the data values for the agricultural data layer from sensors of a tractor or implement during data collection of an application pass.

In one example of the computer implemented method, wherein the parameter comprises a plant summary including coverage, elevation, or vehicle speed, a closing force parameter or a down force parameter including an applied force, an average force, a force margin, a minimum force, or a force state, an insecticide or weed & feed parameter, a nitrogen, a starter, a fungicide parameter, or a seeding parameter including a crop hybrid, a population, a population state, a seeding tank, a singulation, or a SRI.

In an aspect of the disclosure there is provided a system comprising a display device for displaying a graphical user interface having a field view with data values for a parameter for an agricultural data layer for an agricultural field and a diagnostics view and at least one processor coupled to the display device. The at least one processor is configured to execution instructions to receive a user input for selecting the parameter for the agricultural data layer, to generate and display the agricultural data layer in the field view based on the user input, to receive selection of one or more locations in the field view, and to generate and display a flag to display an associated data value for each selected location in the field view.

In one example of the system, wherein the at least one processor is configured to execute instructions to receive user input to initiate a replay functionality for replaying a route of a tractor during an application pass.

In one example of the system, wherein the at least one processor is configured to execute instructions to generate a video replay for the field view with a tractor icon moving across the agricultural data layer for the selected parameter based on the user input to initiate replay functionality.

In one example of the system, wherein the at least one processor is configured to execute instructions to generate a pop up window or a side by side window to display a data value that is associated with a location of the tractor icon and the data value updates as the tractor icon moves along a route of a tractor during data collection from an application pass.

In one example of the system, wherein the pop up window or the side by side window to display one or more data values including a data value for a first parameter and a data value for a second parameter that are associated with the location of the tractor icon.

In one example of the system, wherein the at least one processor is configured to execute instructions to generate diagnostics for the diagnostics view including force diagnostics for any location in the field or machine sensors readings including voltages, a meter vacuum, a duty cycle, encoder counts, or CAN network statistics from an implement bus.

In an aspect of the disclosure there is provided a computer implemented method for providing a viewing functionality for agricultural data layers in a field view of a user interface of a software application. The method includes receiving a user input for selecting a first parameter for a first agricultural data layer, generating and displaying the first agricultural data layer in the field view based on the user input, receiving, with the user interface of the software application, selection of a target point at a first location of the first agricultural data layer in the field view, and generating and displaying a first data value for the selected first location in a field based on the user input.

In one example of the computer implemented method, further comprising receiving user input for moving the target point to a second location of the first agricultural data layer in the field view, and generating and displaying a second data value of the first agricultural data layer for the selected second location in the field based on the user input.

In one example of the computer implemented method, wherein the software application comprises a mobile software application that is displayed on a mobile device.

In one example of the computer implemented method, further comprising receiving a user input to select a second parameter for a second agricultural data layer from a parameter region, generating and displaying the second agricultural data layer in a second portion of the field view based on the user input.

In one example of the computer implemented method, further comprising automatically resizing the first agricultural data layer in a first portion of the field view for a split view of the first and second data layers.

In one example of the computer implemented method, wherein the second portion of the field view displays the target point at the second location in the second agricultural data layer and shows a data value at this second location when the target point is positioned at second location in the field for the first agricultural data layer.

In one example of the computer implemented method, further comprising receiving user input for moving the target point to a third location of the first data layer in the field view; and generating and displaying a data value in the first data layer and a data value in the second data layer for the third location in the field based on the target point being positioned at the third location.

### BRIEF DESCRIPTION OF THE DRAWINGS

The present disclosure is illustrated by way of example, and not by way of limitation, in the figures of the accompanying drawings and in which:

FIG. 1 shows an example of a system for performing agricultural operations (e.g., planting operations) of agricultural fields including operations of an implement having row units in accordance with one embodiment.

FIG. 2 illustrates a flow diagram of one embodiment for a method 200 of providing a replay functionality for agricultural data layers collected during agricultural operations of an agricultural field.

FIGS. 3-4 illustrate user interfaces with a field view and a diagnostics view (or data metrics view) in accordance with one embodiment.

FIG. 5 illustrates a flow diagram of one embodiment for a method 500 of providing a viewing functionality for agricultural data layers collected during agricultural operations of an agricultural field.

FIG. 6 illustrates a user interface 601 for selecting a parameter (or data layer) from a parameter region 602 in accordance with one embodiment.

FIGS. 7-10 illustrate user interfaces for moving a target point within a field view in accordance with one embodiment.

FIG. 11 shows an example of a block diagram of a self-propelled implement 140 (e.g., sprayer, spreader, irrigation implement, etc.) in accordance with one embodiment.

FIG. 12 shows an example of a block diagram of a system 100 that includes a machine 102 (e.g., tractor, combine harvester, etc.) and an implement 1240 (e.g., planter, cultivator, plough, sprayer, spreader, irrigation implement, etc.) in accordance with one embodiment.

FIG. 13 is a side elevation view of a row unit 10 of an agricultural planter with a seed firmer 1300 mounted to the row unit 10.

### DETAILED DESCRIPTION

All references cited herein are incorporated herein in their entireties. If there is a conflict between a definition herein and in an incorporated reference, the definition herein shall control. At least one of A, B, and C refers to a selection of A alone, B alone, C alone, a combination of A and B, a combination of A and C, a combination of B and C, or a combination of A and B and C.

Described herein are systems and a method for providing a replay functionality for agricultural data layers in a field view of a graphical user interface of a software application. The graphical user interface generates and displays the agricultural data layer in the field view based on the user input, receives, with the graphical user interface, selection of one or more locations in the field view, and generates and displays a notification (e.g., a flag) to display an associated data value for each selected location in the field view.

The replay functionality allows a user (e.g., a farmer, an operator, a dealer, an owner) to look back into the field that had an application pass, and see what happened on their in-cab monitor retroactively—in many cases, issues occur while actively planting, applying, or harvesting, and this allows the user to review data to indicate what has happened instead of having to recreate the issue to diagnose or understand the issue. This can be done during non-operating time such as rain delays, or other time that doesn't require recreating the problem for a user of the online application to understand the issue and the underlying cause of the issue. This ability results in less down time, and provides the dealer or user an ability to view diagnostics and fix the issue before the implement is back operating in the field. Also, part of this benefit of the replay functionality is being able to select a point or location in the field to replay or view the monitor data as seen in the tractor cab during the application pass from that specific position. This allows a user to quickly locate a point in the field that the user wants to replay, or review for trouble shooting and understanding what is happening agronomically in the field.

While illustrated with visualized data obtained from agricultural fields, the described operations can be used with any visualized data. In one embodiment, a data processing system (e.g., planter monitor of a cab, display system, tractor, machine, apparatus, computing device, user device, drone, self-guided device, self-propelled device, etc) can generate and cause a display device to display a localized view map layer that is geographically associated with a selected region of a field map.

In the following description, numerous details are set forth. It will be apparent, however, to one skilled in the art, that embodiments of the present disclosure may be practiced without these specific details. In some instances, well-known structures and devices are shown in block diagram form, rather than in detail, in order to avoid obscuring the present disclosure.

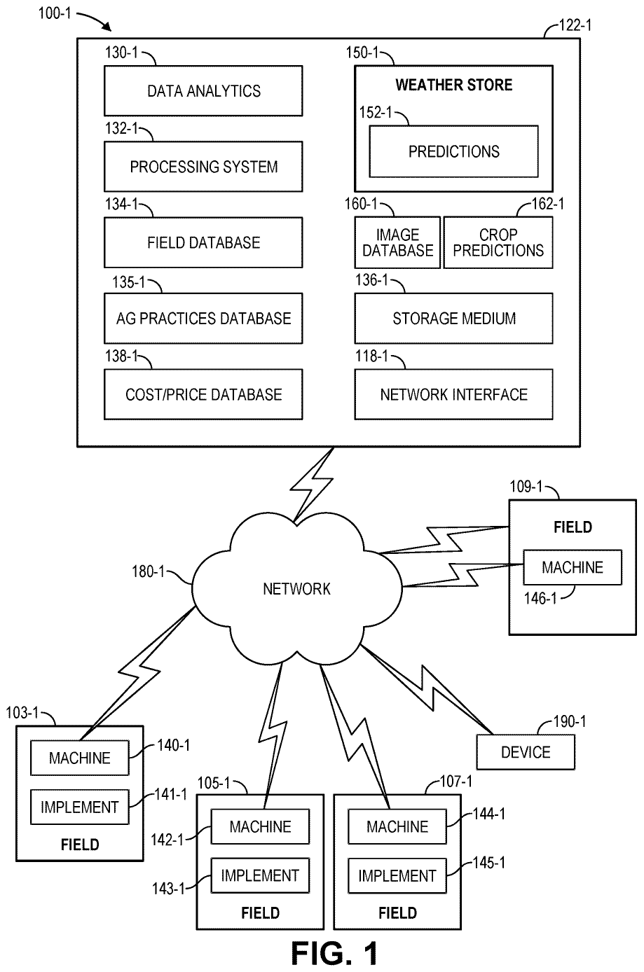

FIG. 1 shows an example of a system for performing agricultural operations (e.g., planting operations, tillage operations, irrigation operations, fluid operations, etc.) of agricultural fields including operations of an implement having row units in accordance with one embodiment. For example, and in one embodiment, the system 100-1 may be implemented as a cloud based system with servers, data processing devices, computers, etc. Aspects, features, and functionality of the system 100-1 can be implemented in servers, planters, planter monitors, combines, implements, laptops, tablets, computer terminals, client devices, user devices (e.g., device 190-1), handheld computers, personal digital assistants, cellular telephones, cameras, smart phones, mobile phones, computing devices, or a combination of any of these or other data processing devices.

In other embodiments, the system includes a network computer or an embedded processing device within another device (e.g., display device) or within a machine (e.g., planter, combine), or other types of data processing systems having fewer components or perhaps more components than that shown in FIG. 1. The system 100-1 (e.g., cloud based system) and agricultural operations can control and monitor planting operations for planting within a planting furrow or trench using an implement or machine. The system 100-1 includes machines 140-1, 142-1, 144-1, 146-1 and implements 141-1, 143-1, 145-1 coupled to a respective machine. The implements (or machines) can include row units for planting operations of rows of crops within associated fields (e.g., fields 103-1, 105-1, 107-1, 109-1). The system 100-1 includes an agricultural analysis system 122-1 that includes a weather store 150-1 with current and historical weather data, weather predictions module 152-1 with weather predictions for different regions, and at least one processing system 132-1 for executing instructions for controlling and monitoring different operations (e.g., planting, fertilizing). The storage medium 136-1 may store instructions, software, software programs, etc. for execution by the processing system and for performing operations of the agricultural analysis system 122-1. In one example, storage medium 136-1 may contain a planting prescription (e.g., planting prescription that relates georeferenced positions in the field to planting parameters (e.g., soil type, downforce, speed, seed orientation, etc.). The implement 141-1 (or any of the implements) may include an implement 200-1 whose sensors and/or controllers may be specifically the elements that are in communication with the network 180-1 for sending control signals or receiving as-applied data.

An image database 160-1 stores captured images of plants or crops at different growth stages and seed at different positions and orientation in a seed passageway during planting. A data analytics module 130-1 may perform analytics on agricultural data (e.g., images, weather, field, yield, etc.) to generate crop predictions 162-1 relating to agricultural operations.

A field information database 134-1 stores agricultural data (e.g., crop growth stage, soil types, soil characteristics, moisture holding capacity, etc.) for the fields that are being monitored by the system 100-1. An agricultural practices information database 135-1 stores farm practices information (e.g., as-applied planting information (e.g., seed orientation), as-applied spraying information, as-applied fertilization information, planting population, applied nutrients (e.g., nitrogen), yield levels, proprietary indices (e.g., ratio of seed population to a soil parameter), etc.) for the fields that are being monitored by the system 100-1. An implement can obtain seed orientation data and provide this data to the system 100-1. A cost/price database 138-1 stores input cost information (e.g., cost of seed, cost of nutrients (e.g., nitrogen)) and commodity price information (e.g., revenue from crop).

The system 100-1 shown in FIG. 1 may include a network interface 118-1 for communicating with other systems or devices such as drone devices, user devices, and machines (e.g., planters, combines) via a network 180-1 (e.g., Internet, wide area network, WiMax, satellite, cellular, IP network, etc.). The network interface include one or more types of transceivers for communicating via the network 180-1.

The processing system 132-1 may include one or more microprocessors, processors, a system on a chip (integrated circuit), or one or more microcontrollers. The processing system includes processing logic for executing software instructions of methods describe herein and software programs. The system 100-1 includes the storage medium 136-1 for storing data and programs for execution by the processing system. The storage medium 136-1 can store, for example, software components such as a software application for controlling and monitoring planting operations or any other software application for providing viewing and replay functionality for diagnostics and troubleshooting. The storage medium 136-1 can be any known form of a machine readable non-transitory storage medium, such as semiconductor memory (e.g., flash; SRAM; DRAM; etc.) or non-volatile memory, such as hard disks or solid-state drive.

While the storage medium (e.g., machine-accessible non-transitory medium) is shown in an exemplary embodiment to be a single medium, the term “machine-accessible non-transitory medium” should be taken to include a single medium or multiple media (e.g., a centralized or distributed database, and/or associated caches and servers) that store the one or more sets of instructions. The term “machine-accessible non-transitory medium” shall also be taken to include any medium that is capable of storing, encoding or carrying a set of instructions for execution by the machine and that cause the machine to perform any one or more of the methodologies of the present disclosure. The term “machine-accessible non-transitory medium” shall accordingly be taken to include, but not be limited to, solid-state memories, optical and magnetic media, and carrier wave signals.

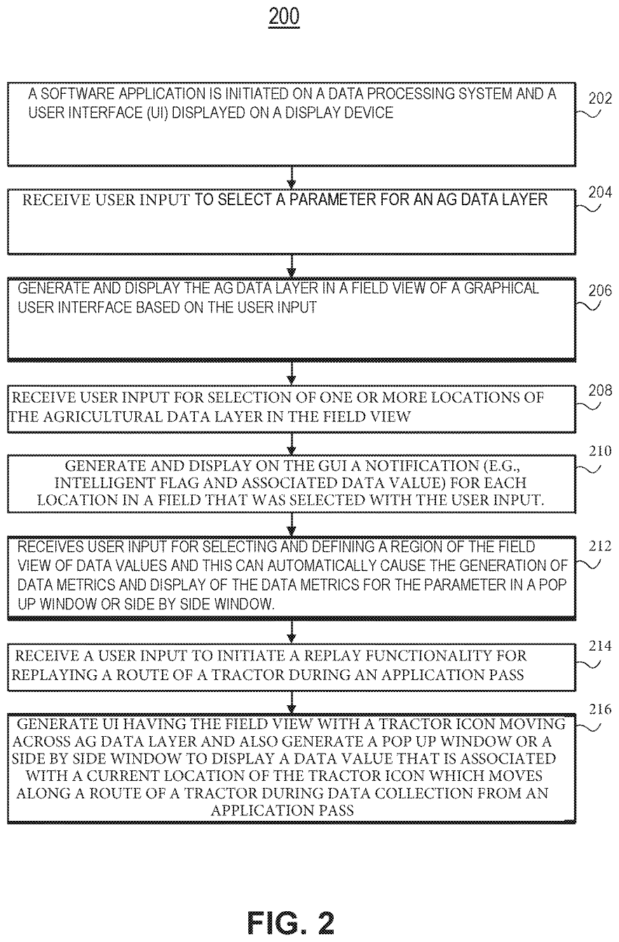

FIG. 2 illustrates a flow diagram of one embodiment for a method 200 of providing a replay functionality for agricultural data layers collected during agricultural operations of an agricultural field. The method 200 is performed by processing logic that may comprise hardware (circuitry, dedicated logic, graphics processing unit (GPU), etc.), software (such as is run on a general purpose computer system or a dedicated machine or a device), or a combination of both. In one embodiment, the method 200 is performed by processing logic of at least one data processing system (e.g., system 100-1, machine, apparatus, monitor, display device, computing device, user device, self-guided device, self-propelled device, etc.). The data processing system executes instructions of a software application or program with processing logic. The software application or program can be initiated by the data processing system. In one example, a monitor or display device receives user input and provides a customized display for operations of the method 200.

At operation 202, a software application (e.g., cloud based application, mobile application) is initiated on a data processing system (e.g., system 100-1, processing system 132-1, 1200, 162, machine, apparatus, user device, self-guided device, self-propelled device, etc.) and displayed on a monitor or display device as a user interface. The data processing system may be integrated with or coupled to a machine that performs an application pass (e.g., planting, tillage, fertilization, irrigation, etc.). Alternatively, the data processing system may be integrated with an apparatus (e.g., drone, image capture device) associated with the machine that captures images during the application pass. The user interface can include different selectable system parameters (e.g., plant summary (e.g., coverage, elevation, vehicle speed), closing force parameter (e.g., applied force, average force, force margin, minimum force, force state), down force parameter (e.g., applied force, average force, force margin, minimum force, force state), insecticide or weed & feed parameter (e.g., magnitude, deviation, uniformity, blockage), nitrogen, starter, or fungicide parameter (e.g., flow, flow state), seeding (e.g., crop hybrid, population, population state, seeding tank, singulation, SRI, meter vacuum), organic matter, temperature, vehicle or implement speed, or any measured property) of a field view region, a mapping region to select a map option (e.g., map with details, full width map, region explorer function, split map comparison, and diagnostic timeline), and the field view region.

At operation 204, the graphical user interface (GUI) of the software application receives user input to select a parameter for an agricultural data layer. At operation 206, the method generates and displays the agricultural data layer in a field view of the GUI based on the user input. The data layer includes various data values at different locations in a field for the selected parameter. The data values are collected from sensors of a tractor or implement during data collection of an application pass (e.g., planting operation, spraying operation, tillage operation, etc.). Any data layer with continuous data can be displayed in the field view.

At operation 208, the GUI receives user input (e.g., mouse input, touch user input, any type of user input, expand that can refer to positive expansion or negative expansion (contraction), pan) for selection of one or more locations for the agricultural data layer in the field view.

At operation 210, the method generates and displays on the GUI a notification (e.g., intelligent flag and associated data value) for each location in a field that was selected with the user input.

At operation 212, the GUI of the software application optionally receives user input (e.g., multipoint mouse input, multipoint touch user input, any type of user input, 4 point input to draw the polygon) for selecting and defining a region of the field view of data values and this can automatically cause the generation of data metrics and display of the data metrics (e.g., minimum data value in the selected region, maximum data value in the selected region, average data value in the selected region, histogram for the data values in the selected region) for the first parameter in a pop up window or side by side window.

At operation 214, the software application receives user input to initiate a replay functionality for replaying a route of a tractor during an application pass. At operation 216, the software application generates a graphical user interface having the field view with a tractor icon moving across a data layer for the selected parameter and also generates a pop up window or a side by side window to display a data value for the selected parameter that is associated with a current location of the tractor icon, which moves along a route of a tractor during data collection from an application pass (e.g., planting operation, spraying operation, tillage operation, etc.). The user interface is generated based on the user input and a first portion of the user interface may include a field view of data values for the selected parameter and a range region for a range of data values of the selected parameter. The second portion of the user interface displays the pop up window or a side by side window to display one or more data values (e.g., data value for a first parameter, data value for a second parameter) that are associated with the current location of the tractor icon and possibly other data metrics for the selected region from the multi-point user input.

A selection of a different parameter will cause the field view to display a data layer for a different parameter. In some embodiments, the operations of the method(s) disclosed herein can be altered, modified, combined, or deleted. In one example, the operations 214 and 216 can occur independently from other operations of the method 200. The methods in embodiments of the present disclosure may be performed with a device, an apparatus, or data processing system as described herein. The device, apparatus, or data processing system may be a conventional, general-purpose computer system or special purpose computers, which are designed or programmed to perform only one function, may also be used.

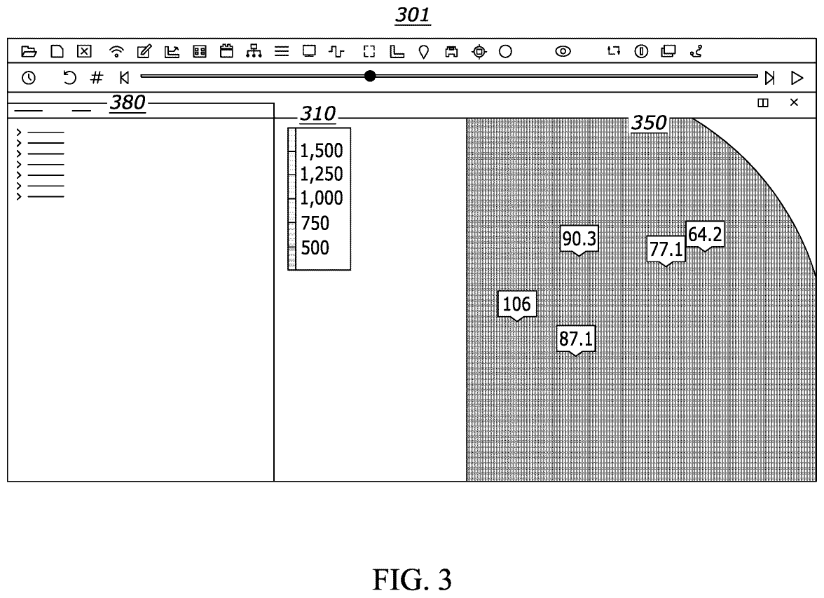

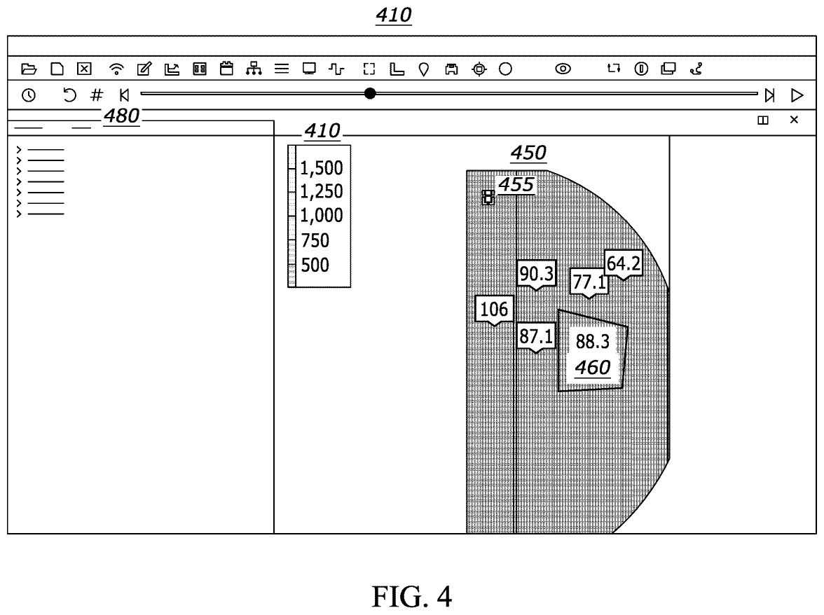

FIGS. 3-4 illustrate user interfaces with a field view and a diagnostics view (or data metrics view) in accordance with one embodiment. An initiated software application (e.g., field application) of a data processing system generates the graphical user interface (GUI) 301 that is displayed by the monitor or display device.

The GUI can provide different display regions that are selectable by a user. In one example, the display regions include a system parameter region having a plurality of parameters (e.g., plant summary (e.g., coverage, elevation, vehicle speed), closing force parameter (e.g., applied force, average force, force margin, minimum force, force state), down force parameter (e.g., applied force, average force, force margin, minimum force, force state), insecticide or weed & feed parameter (e.g., magnitude, deviation, uniformity, blockage), nitrogen, starter, or fungicide parameter (e.g., flow, flow state), seeding (e.g., crop hybrid, population, population state, seeding tank, singulation, SRI, meter vacuum), organic matter, temperature, vehicle or implement speed, or any measured property), a range region (e.g., range region 310, range region 410) having adjustable color steps, a field view region (e.g., field view 350, field view 450) having a data layer for the selected parameter, and a diagnostic view (e.g., view 380, view 480).

As discussed for method 200, the software application can receive user input for selection of one or more locations in the field view (e.g., field view 350, field view 450). The software application generates and displays a notification (e.g., an intelligent flag and associated data value or event code) such as 106, 90.3, 87.1, 77.1, 64.2 for each location in a field that was selected with the user input.

The software application optionally receives user input (e.g., multipoint mouse input, multipoint touch user input, any type of user input, 4 point input to draw the polygon) for selecting and defining a region 460 of the field view of data values and this can automatically cause the generation of data metrics and display of the data metrics (e.g., minimum data value in the selected region, maximum data value in the selected region, average data value in the selected region, histogram for the data values in the selected region) for the first parameter in a pop up window or side by side window.

The software application can receive user input to initiate a replay functionality for replaying a route of a tractor during an application pass. The software application generates a user interface 401 having the field view 450 with a tractor icon 455 moving across a data layer for the selected parameter and also generates a pop up window or a side by side window 480 to display a current data value that is associated with a current location of the tractor icon, which moves along a route of a tractor or implement during data collection from an application pass (e.g., planting operation, spraying operation, tillage operation, etc.). The replay functionality displays the tractor icon following the same route through rows in the field as the tractor (or implement) did during the data collection and application pass. The view 480 can include diagnostics (e.g., force diagnostics for any location, machine sensors readings (e.g., voltages, meter vacuum, duty cycle, encoder counts, CAN network statistics from an implement bus), a down force sensor reading, diagnostics for a solenoid row cylinder of a row unit, etc.) and data metrics (e.g., minimum data value in the selected region, maximum data value in the selected region, average data value in the selected region, histogram for the data values in the selected region) for the selected parameter.

A user (e.g., grower, dealer) can trouble shoot any issues during operation of a machine or implement based on the diagnostics. The diagnostics provide an ability to show a specific location in a field for an event code (e.g., first event code to indicate a duty cycle for a sensor is outside of an operating range, second event code to indicate force diagnostics for any location is outside of an operating range, etc.) that is displayed with a flag on the field view. This allows the grower or dealer to understand what is happening agronomically in the field.

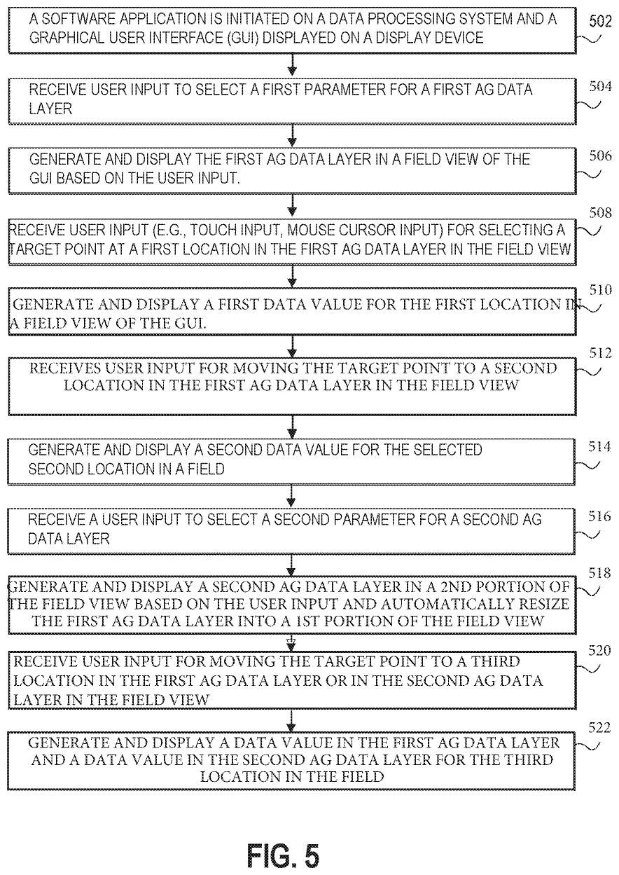

FIG. 5 illustrates a flow diagram of one embodiment for a method 500 of providing a viewing functionality for agricultural data layers collected during agricultural operations of an agricultural field. The method 500 is performed by processing logic that may comprise hardware (circuitry, dedicated logic, graphics processing unit (GPU), etc.), software (such as is run on a general purpose computer system or a dedicated machine or a device), or a combination of both. In one embodiment, the method 500 is performed by processing logic of at least one data processing system (e.g., system 100-1, machine, apparatus, monitor, display device, computing device, user device, self-guided device, self-propelled device, etc.). The data processing system executes instructions of a software application or program with processing logic. The software application or program can be initiated by the data processing system. In one example, a monitor or display device receives user input and provides a customized display for operations of the method 500.

At operation 502, a software application (e.g., cloud based application, mobile application) is initiated on a data processing system (e.g., system 100-1, processing system 132-1, 1200, 162, machine, apparatus, user device, mobile device, self-guided device, self-propelled device, etc.) and displayed on a monitor or display device as a user interface. The data processing system may be integrated with or coupled to a machine that performs an application pass (e.g., planting, tillage, fertilization, irrigation, etc.). Alternatively, the data processing system may be integrated with an apparatus (e.g., drone, image capture device) associated with the machine that captures images during the application pass. The user interface can include different selectable system parameters (e.g., plant summary (e.g., coverage, elevation, vehicle speed), closing force parameter (e.g., applied force, average force, force margin, minimum force, force state), down force parameter (e.g., applied force, average force, force margin, minimum force, force state), insecticide or weed & feed parameter (e.g., magnitude, deviation, uniformity, blockage), nitrogen, starter, or fungicide parameter (e.g., flow, flow state), seeding (e.g., crop hybrid, population, population state, seeding tank, singulation, SRI, meter vacuum), organic matter, temperature, vehicle or implement speed, or any measured property) of a field view region, a mapping region to select a map option (e.g., map with details, full width map, region explorer function, split map comparison, and diagnostic timeline), and the field view region.

At operation 504, the graphic user interface (GUI) of the software application receives user input to select a first parameter for a first agricultural data layer from a system parameter region. Other settings can also be selected such as a field and a growing season. At operation 506, the method generates and displays a first data layer in a field view of the GUI based on the user input. The first data layer includes various data values at different locations in a field for the selected first parameter. The data values are collected from sensors of a tractor or implement during data collection of an application pass (e.g., planting operation, spraying operation, tillage operation, etc.).

At operation 508, the software application receives user input (e.g., touch input, mouse cursor input, any type of user input, expand that can refer to positive expansion or negative expansion (contraction), pan) for selection of a target point for a first location for the agricultural data layer in the field view. A first expand operation can be a pinch motion with 2 user input points contacting the field view and moving towards each other to expand in (or contract) (e.g., 1 finger and 1 thumb or 2 fingers). A second expand operation (e.g., expand with 2 user input points contacting the field view moving away from each other to expand out) causes the field view to expand out. A panning input (e.g., panning with 1 user input point contacting the field view and moving in any direction, e.g., 1 finger or 1 thumb) to move within the field view.

At operation 510, the method generates and displays a first data value for the selected first location in a field that was selected with the user input. The target point can be moved to different locations to show different data values. The data layer being displayed is the same data layer collected by the implement and displayed in a tractor's cab during an application pass.

At operation 512, the software application receives user input for moving the target point (e.g., target box, target guide) to a second location in the first agricultural data layer in the field view. At operation 514, the method generates and displays on the GUI a second data value for the selected second location in a field that was selected with the user input.

At operation 516, the software application receives a user input to select a second parameter for a second agricultural data layer from a system parameter region. At operation 518, the method generates and displays a second data layer in a second portion of the field view based on the user input and automatically resizes (e.g., reduces) the first data layer into a first portion of the field view for a split view of the first and second data layers. Otherwise, if no dynamic automatic resizing of the first data layer occurs, then the first data layer would continue to occupy most or all of the field view and the second data layer would be obscured from a user's view or a separate view of the second data layer would obscure the first data layer from the user's view. The second data layer includes various data values at different locations in a field for the selected second parameter. The data values are collected from sensors of a tractor or implement during data collection of an application pass (e.g., planting operation, spraying operation, tillage operation, etc.).

If a user has previously moved the target point to the second location in the field for the first parameter, then the second portion of the field view will show the target point at the second location in the second data layer and show a data value at this second location. In this manner, a user can compare data values for multiple parameters at a specific location in a field. In one example, a user can compare average population in a top portion of the field view and average spacing in a bottom portion of the field view.

At operation 520, the software application receives user input for moving the target point to a third location in the first data layer or in the second data layer in the field view. At operation 522, the method generates and displays in the GUI a data value in the first data layer and a data value in the second data layer for the third location in the field that was selected with the user input.

In some embodiments, the operations of the method(s) disclosed herein can be altered, modified, combined, or deleted. The methods in embodiments of the present disclosure may be performed with a device, an apparatus, or data processing system as described herein. The device, apparatus, or data processing system may be a conventional, general-purpose computer system or special purpose computers, which are designed or programmed to perform only one function, may also be used.

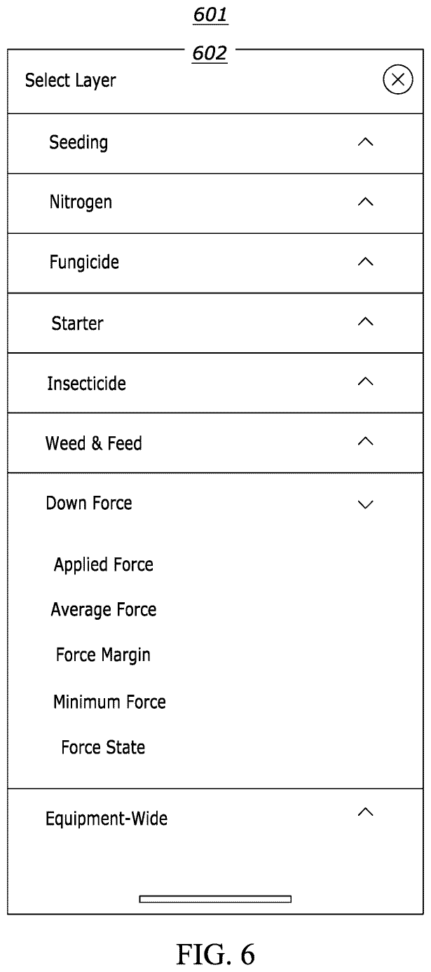

FIG. 6 illustrates a user interface 601 for selecting a parameter (or data layer) from a parameter region 602 in accordance with one embodiment. The parameter region 602 may include a plurality of parameters (e.g., plant summary (e.g., coverage, elevation, vehicle speed), closing force parameter (e.g., applied force, average force, force margin, minimum force, force state), down force parameter (e.g., applied force, average force, force margin, minimum force, force state), insecticide or weed & feed parameter (e.g., magnitude, deviation, uniformity, blockage), nitrogen, starter, or fungicide parameter (e.g., flow, flow state), seeding (e.g., crop hybrid, population, population state, seeding tank, singulation, SRI, meter vacuum), organic matter, temperature, vehicle or implement speed, or any measured property). SRI displays an average Seed Release Index for a planter. Seed Release Index measures the consistency of seed drop. The lower the number, the more consistent the seed drop.

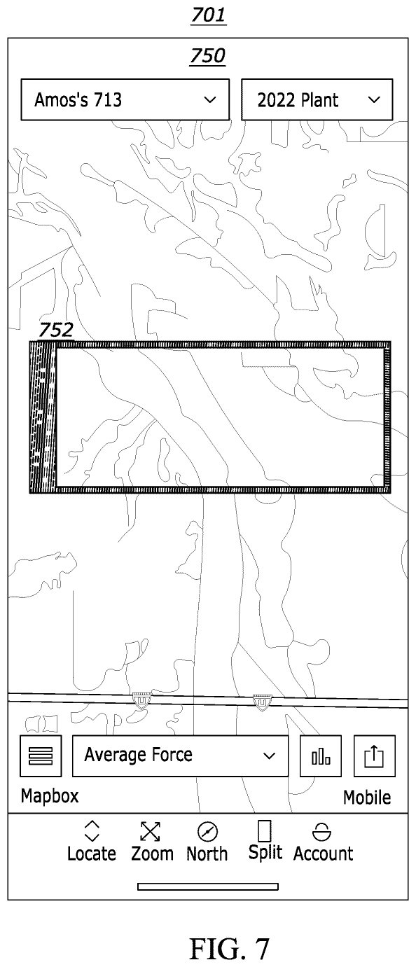

FIGS. 7-10 illustrate graphical user interfaces for moving a target point within a field view in accordance with one embodiment. An initiated software application (e.g., cloud based application, mobile application) is initiated on a data processing system (e.g., system 100-1, processing system 132-1, 1200, 162, machine, apparatus, user device, mobile device, self-guided device, self-propelled device, etc.) and displayed on a monitor or display device as a user interface 701 due to a user selecting down force and average force from the GIU 601.

A user can select a field, a season, and a parameter for the GUI 701 that displays the data values in a data layer 752 of the selected parameter in a field view 750.

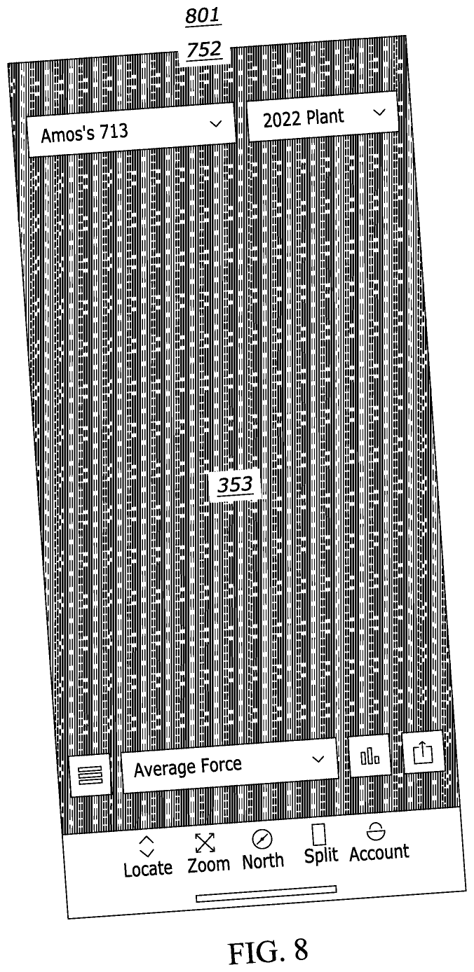

As discussed for method 500, the software application can receive user input (e.g., touch input, mouse cursor input, any type of user input, expand that can refer to positive expansion or negative expansion (contraction), pan) for selecting a target point at a first location in the first data layer in the field view. The method generates and displays in the GUI 801 a specific first data value (e.g., 353) for the selected first location in a field view that was selected with the user input as illustrated in GUI 801 of FIG. 8. The target point can be moved with user input to different locations to show different data values.

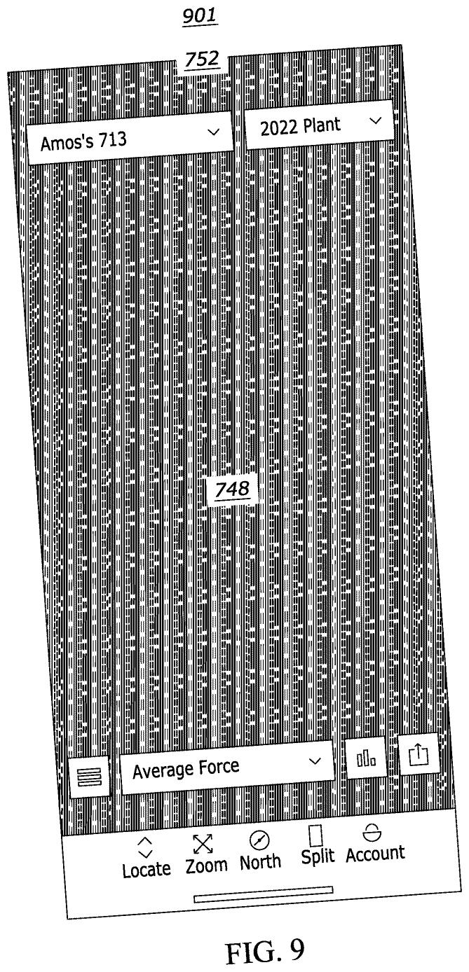

The software application receives user input for moving the target point to a second location in the first data layer in the field view. The method generates and displays a specific second data value (e.g., 748) for the selected second location in a field that was selected with the user input as illustrated in GUI 901 of FIG. 9.

The software application can receive a user input to select a second parameter (or second data layer) from a system parameter region. The method generates and displays a second data layer 1060 in a second portion of the field view of the GUI 1001 based on the user input and automatically resizes the first data layer 752 into a first portion of the field view for a split view of the first and second data layers (instead of having the first data layer occupy most or all of the field view). The second data layer 1060 includes various data values at different locations in a field for the selected second parameter. The data values are collected from sensors of a tractor or implement during data collection of an application pass (e.g., planting operation, spraying operation, tillage operation, etc.).

If a user has previously moved the target point 754a of the data layer 752 to the second location in the field for the first parameter, then the second portion of the field view will show the target point 754b at the same second location in the second data layer and show a data value (e.g., 32,110) at this second location. In this manner, a user can compare data values for multiple parameters at a specific location in a field. In the user interface 1001, a user is comparing average force data layer 752 in a top portion of the field view and population data layer 1060 in a lower portion of the field view. In another example, a user can compare average population in a top portion of the field view and average spacing in a bottom portion of the field view.

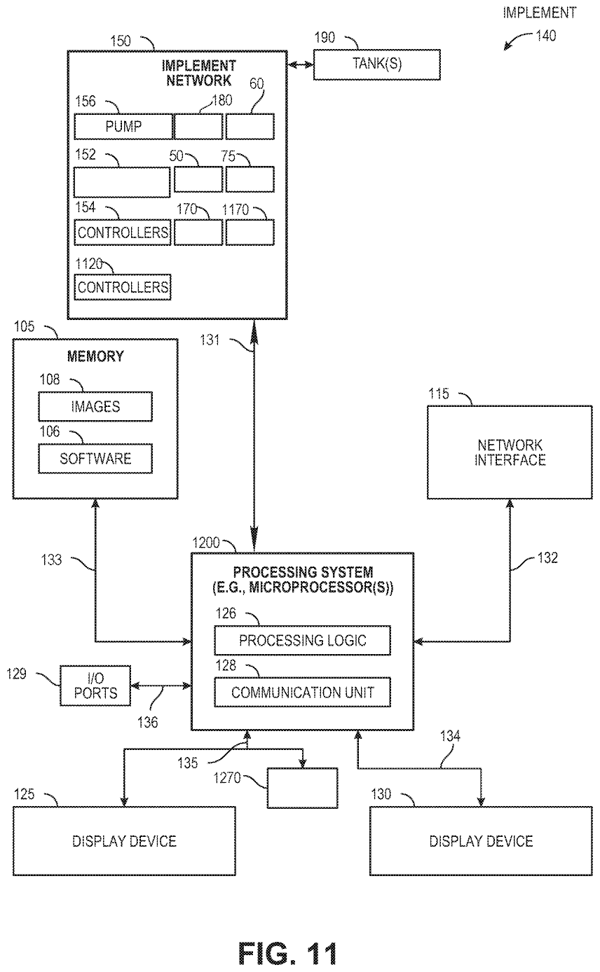

FIG. 11 shows an example of a block diagram of a self-propelled implement 140 (e.g., sprayer, spreader, irrigation implement, etc.) in accordance with one embodiment. The implement 140 includes a processing system 1200, memory 105, and a network interface 115 for communicating with other systems or devices. The network interface 115 can include at least one of a GPS transceiver, a WLAN transceiver (e.g., WiFi), an infrared transceiver, a Bluetooth transceiver, Ethernet, or other interfaces from communications with other devices and systems. The network interface 115 may be integrated with the implement network 150 or separate from the implement network 150 as illustrated in FIG. 11. The I/O ports 129 (e.g., diagnostic/on board diagnostic (OBD) port) enable communication with another data processing system or device (e.g., display devices, sensors, etc.).

In one example, the self-propelled implement 140 performs operations for planting applications of a field. Data associated with the planting applications can be displayed on at least one of the display devices 125 and 130.

The processing system 1200 may include one or more microprocessors, processors, a system on a chip (integrated circuit), or one or more microcontrollers. The processing system includes processing logic 126 for executing software instructions of one or more programs and a communication unit 128 (e.g., transmitter, transceiver) for transmitting and receiving communications from the network interface 115 or implement network 150. The communication unit 128 may be integrated with the processing system or separate from the processing system.

Processing logic 126 including one or more processors may process the communications received from the communication unit 128 including agricultural data (e.g., planting data, GPS data, fluid application data, flow rates, etc.). The system 1200 includes memory 105 for storing data and programs for execution (software 106) by the processing system. The memory 105 can store, for example, software components such as application software for analysis of planting applications for performing operations of the present disclosure, or any other software application or module, reflectance signals from sensor arrays, images (e.g., images of seed in a seed passageway, captured images of crops, images of a spray pattern for rows of crops, images for camera calibrations), alerts, maps, etc. The memory 105 can be any known form of a machine readable non-transitory storage medium, such as semiconductor memory (e.g., flash; SRAM; DRAM; etc.) or non-volatile memory, such as hard disks or solid-state drive. The system can also include an audio input/output subsystem (not shown) which may include a microphone and a speaker for, for example, receiving and sending voice commands or for user authentication or authorization (e.g., biometrics).

The processing system 1200 communicates bi-directionally with memory 105, implement network 150, network interface 115, display device 130, display device 125, and I/O ports 129 via communication links 131-136, respectively.

Display devices 125 and 130 can provide visual user interfaces for a user or operator. The display devices may include display controllers. In one embodiment, the display device 125 is a portable tablet device or computing device with a touchscreen that displays data (e.g., planting application data with seed orientation, liquid or fluid application data, captured images, localized view map layer, high definition field maps of as-applied liquid or fluid application data, as-planted or as-harvested data or other agricultural variables or parameters, yield maps, alerts, etc.) and data generated by an agricultural data analysis software application and receives input from the user or operator for an exploded view of a region of a field, monitoring and controlling field operations. The operations may include configuration of the machine or implement, reporting of data, control of the machine or implement including sensors and controllers, and storage of the data generated. The display device 1230 may be a display (e.g., display provided by an original equipment manufacturer (OEM)) that displays images and data for a localized view map layer, as-applied liquid or fluid application data, as-planted or as-harvested data, yield data, controlling an implement (e.g., planter, tractor, combine, sprayer, etc.), steering the implement, and monitoring the implement (e.g., planter, combine, sprayer, etc.). A cab control module 1270 may include an additional control module for enabling or disabling certain components or devices of the implement.

The implement 140 (e.g., planter, cultivator, plough, sprayer, spreader, irrigation, implement, etc.) includes an implement network 150 having multiple networks. The implement network 150 having multiple networks (e.g., Ethernet network, Power over Ethernet (POE) network, a controller area network (CAN) serial bus protocol network, an ISOBUS network, etc.) may include a pump 156 for pumping liquid or fluid from a storage tank(s) 190 to row units of the implement, communication module 180 for receiving communications from controllers and sensors and transmitting these communications. In one example, the implement network 150 includes nozzles 50, lights 60, and vision system 75 having cameras and processors for various embodiments of this present disclosure.

Sensors 152 (e.g., speed sensors, seed sensors (e.g., a single sensor disposed at one or more orientations, a first sensor at a first orientation, first location of a seed passageway and a second sensor at a second orientation, second location of the seed passageway, a sensor array at a first orientation, a sensor array at a second orientation, or a combination of a first sensor array at a first orientation and second sensor array or sensor at a second orientation, light-emitting diodes (LEDs), laser diodes) having light arrays for detecting passage of seed, downforce sensors, actuator valves, OEM sensors, flow sensors, etc.), controllers 154 (e.g., drive system, GPS receiver), and the processing system 120 control and monitoring operations of the implement. The OEM sensors may be moisture sensors or flow sensors, speed sensors for the implement, fluid application sensors for a sprayer, or vacuum, lift, lower sensors for an implement. For example, the controllers may include processors in communication with a plurality of sensors. The processors are configured to process data (e.g., fluid application data) and transmit processed data to the processing system 120. The controllers and sensors may be used for monitoring motors and drives on the implement.

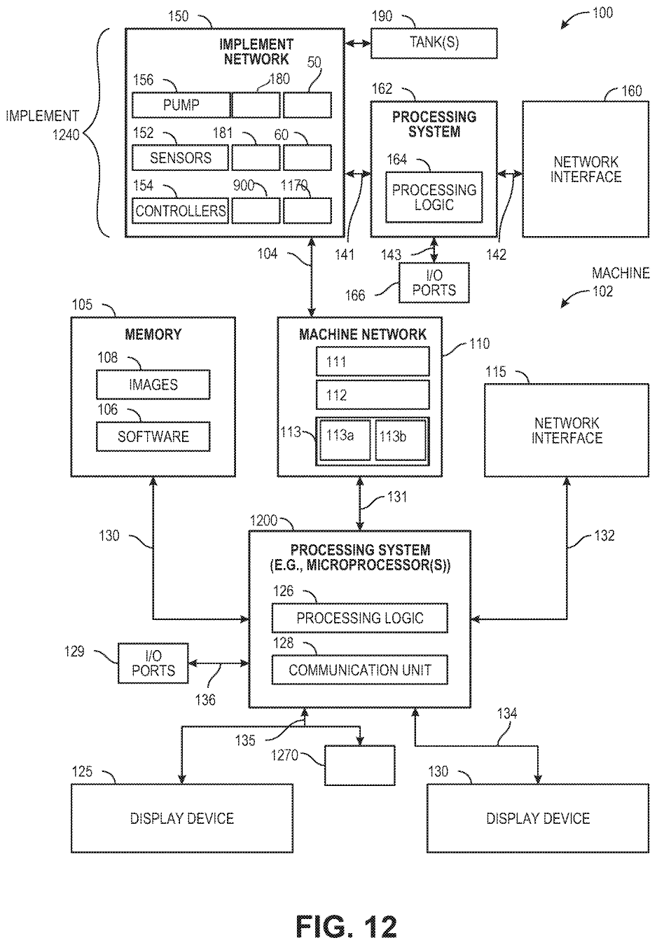

FIG. 12 shows an example of a block diagram of a system 100 that includes a machine 102 (e.g., tractor, combine harvester, etc.) and an implement 1240 (e.g., planter, cultivator, plough, sprayer, spreader, irrigation implement, etc.) in accordance with one embodiment. The machine 102 includes a processing system 1200, memory 105, machine network 110 that includes multiple networks (e.g., an Ethernet network, a network with a switched power line coupled with a communications channel (e.g., Power over Ethernet (POE) network), a controller area network (CAN) serial bus protocol network, an ISOBUS network, etc.), and a network interface 115 for communicating with other systems or devices including the implement 1240. The machine network 110 includes sensors 112 (e.g., speed sensors), controllers 111 (e.g., GPS receiver, radar unit) for controlling and monitoring operations of the machine or implement. The network interface 115 can include at least one of a GPS transceiver, a WLAN transceiver (e.g., WiFi), an infrared transceiver, a Bluetooth transceiver, Ethernet, or other interfaces from communications with other devices and systems including the implement 1240. The network interface 115 may be integrated with the machine network 110 or separate from the machine network 110 as illustrated in FIG. 12. The I/O ports 129 (e.g., diagnostic/on board diagnostic (OBD) port) enable communication with another data processing system or device (e.g., display devices, sensors, etc.).

In one example, the machine is a self-propelled machine that performs operations of a tractor that is coupled to and tows an implement for planting or fluid applications of a field. Data associated with the planting or fluid applications can be displayed on at least one of the display devices 125 and 130.

The processing system 1200 may include one or more microprocessors, processors, a system on a chip (integrated circuit), or one or more microcontrollers. The processing system includes processing logic 126 for executing software instructions of one or more programs and a communication unit 128 (e.g., transmitter, transceiver) for transmitting and receiving communications from the machine via machine network 110 or network interface 115 or implement via implement network 150 or network interface 160. The communication unit 128 may be integrated with the processing system or separate from the processing system. In one embodiment, the communication unit 128 is in data communication with the machine network 110 and implement network 150 via a diagnostic/OBD port of the I/O ports 129 or via network devices 113a and 113b. A communication module 113 includes network devices 113a and 113b. The communication module 113 may be integrated with the communication unit 128 or a separate component.

Processing logic 126 including one or more processors may process the communications received from the communication unit 128 including agricultural data (e.g., planting data with seed orientation data, GPS data, liquid application data, flow rates, weed parameters, a crop identification, a camera height from a camera to a ground level, a crop stress indicator, a drought stress indicator, and insect indicator for different target regions, plant summary (e.g., coverage, elevation, vehicle speed), closing force parameter (e.g., applied force, average force, force margin, minimum force, force state), down force parameter (e.g., applied force, average force, force margin, minimum force, force state), insecticide or weed & feed parameter (e.g., magnitude, deviation, uniformity, blockage), nitrogen, starter, or fungicide parameter (e.g., flow, flow state), seeding (e.g., crop hybrid, population, population state, seeding tank, singulation, SRI, meter vacuum), organic matter, temperature, vehicle or implement speed, or any measured property, etc.). The system 1200 includes memory 105 for storing data and programs for execution (software 106) by the processing system. The memory 105 can store, for example, software components such as field application software for analysis of field applications for performing operations of the present disclosure, or any other software application or module, images (e.g., images of seed in a seed passageway, images for camera calibrations, captured images of crops), alerts, maps, etc. The memory 105 can be any known form of a machine readable non-transitory storage medium, such as semiconductor memory (e.g., flash; SRAM; DRAM; etc.) or non-volatile memory, such as hard disks or solid-state drive. The system can also include an audio input/output subsystem (not shown) which may include a microphone and a speaker for, for example, receiving and sending voice commands or for user authentication or authorization (e.g., biometrics).

The processing system 120 communicates bi-directionally with memory 105, machine network 110, network interface 115, display device 130, display device 125, and I/O ports 129 via communication links 130-136, respectively.

Display devices 125 and 130 can provide visual user interfaces for a user or operator. The display devices may include display controllers. In one embodiment, the display device 125 is a portable tablet device or computing device with a touchscreen that displays data (e.g., seed orientation data, weed parameters, a crop identification, planting application data, liquid or fluid application data, captured images, localized view map layer, high definition field maps of as-applied liquid or fluid application data, as-planted or as-harvested data or other agricultural variables or parameters, yield maps, alerts, etc.) and data generated by an agricultural data analysis software application and receives input from the user or operator for an exploded view of a region of a field, monitoring and controlling field operations. The operations may include configuration of the machine or implement, reporting of data, control of the machine or implement including sensors and controllers, and storage of the data generated. The display device 1230 may be a display (e.g., display provided by an original equipment manufacturer (OEM)) that displays images and data for a localized view map layer, as-applied liquid or fluid application data, as-planted or as-harvested data, yield data, diagnostics data, data metrics, weed parameters, controls a machine (e.g., planter, tractor, combine, sprayer, etc.), steering the machine, and monitoring the machine or an implement (e.g., planter, combine, sprayer, etc.) that is connected to the machine with sensors and controllers located on the machine or implement.

A cab control module 1270 may include an additional control module for enabling or disabling certain components or devices of the machine or implement. For example, if the user or operator is not able to control the machine or implement using one or more of the display devices, then the cab control module may include switches to shut down or turn off components or devices of the machine or implement.

The implement 1240 (e.g., planter, cultivator, plough, sprayer, spreader, irrigation, implement, etc.) includes an implement network 150 having multiple networks, a processing system 162 having processing logic 164, a network interface 160, and optional input/output ports 166 for communicating with other systems or devices including the machine 102. The implement network 150 having multiple networks (e.g, Ethernet network, Power over Ethernet (PoE) network, a controller area network (CAN) serial bus protocol network, an ISOBUS network, etc.) may include a pump 156 for pumping liquid or fluid from a storage tank(s) 190 to row units of the implement, communication modules (e.g., 180, 181) for receiving communications from controllers and sensors and transmitting these communications to the machine network. In one example, the communication modules include first and second network devices with network ports. A first network device with a port (e.g., CAN port) of communication module (CM) 180 receives a communication with data from controllers and sensors, this communication is translated or converted from a first protocol into a second protocol for a second network device (e.g., network device with a switched power line coupled with a communications channel, Ethernet), and the second protocol with data is transmitted from a second network port (e.g., Ethernet port) of CM 180 to a second network port of a second network device 113b of the machine network 110. A first network device 113a having first network ports (e.g., 1-4 CAN ports) transmits and receives communications from first network ports of the implement. In one example, the implement network 150 includes nozzles 50, lights 60, vision system 1170 having cameras and processors, and autosteer controller 900 for various embodiments of this present disclosure. The autosteer controller 900 may also be part of the machine network 110 instead of being located on the implement network 150 or in addition to being located on the implement network 150.

Sensors 152 (e.g., speed sensors, seed sensors (e.g., a single sensor disposed at one or more orientations, a first sensor at a first orientation, first location of a seed passageway and a second sensor at a second orientation, second location of the seed passageway, a sensor array at a first orientation, a sensor array at a second orientation, or a combination of a first sensor array at a first orientation and second sensor array or sensor at a second orientation) for detecting passage of seed, downforce sensors, actuator valves, OEM sensors, flow sensors, etc.), controllers 154 (e.g., drive system for seed meter, GPS receiver), and the processing system 162 control and monitoring operations of the implement.

The OEM sensors may be moisture sensors or flow sensors for a combine, speed sensors for the machine, seed force sensors for a planter, liquid application sensors for a sprayer, or vacuum, lift, lower sensors for an implement. For example, the controllers may include processors in communication with a plurality of seed sensors. The processors are configured to process data (e.g., liquid application data, seed sensor data) and transmit processed data to the processing system 162 or 120. The controllers and sensors may be used for monitoring motors and drives on a planter including a variable rate drive system for changing plant populations. The controllers and sensors may also provide swath control to shut off individual rows or sections of the planter. The sensors and controllers may sense changes in an electric motor that controls each row of a planter individually. These sensors and controllers may sense seed delivery speeds in a seed tube for each row of a planter.

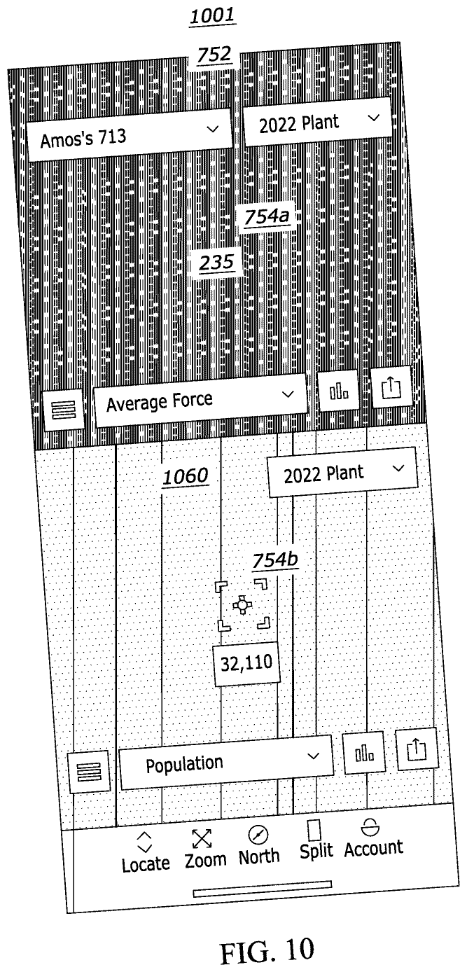

The network interface 160 can be a GPS transceiver, a WLAN transceiver (e.g., WiFi), an infrared transceiver, a Bluetooth transceiver, Ethernet, or other interfaces from communications with other devices and systems including the machine 102. The network interface 160 may be integrated with the implement network 150 or separate from the implement network 150 as illustrated in FIG. 10.

The processing system 162 communicates bi-directionally with the implement network 150, network interface 160, and I/O ports 166 via communication links 141-143, respectively. The implement communicates with the machine via wired and possibly also wireless bi-directional communications 104. The implement network 150 may communicate directly with the machine network 110 or via the network interfaces 115 and 160. The implement may also by physically coupled to the machine for agricultural operations (e.g., planting, harvesting, spraying, etc.). The memory 105 may be a machine-accessible non-transitory medium on which is stored one or more sets of instructions (e.g., software 106) embodying any one or more of the methodologies or functions described herein. The software 106 may also reside, completely or at least partially, within the memory 105 and/or within the processing system 1200 during execution thereof by the system 100, the memory and the processing system also constituting machine-accessible storage media. The software 1206 may further be transmitted or received over a network via the network interface 115.

In one example, the implement 140, 1240 is an autosteered implement comprising a self-propelled implement with an autosteer controller 1120 for controlling traveling of the self-propelled implement. The controllers 154 include a global positioning system to provide GPS coordinates. The vision guidance system 1170 includes at least one camera and a processor. The global positioning system is in communication with the processor, and the processor is in communication with the autosteer controller. The processor is configured to modify the GPS coordinates to a modified GPS coordinates to maintain a desired travel for the self-propelled implement.

In another example, the machine 102 is an autosteered machine comprising a self-propelled machine with an autosteer controller 1120 for controlling traveling of the self-propelled machine and any implement that is coupled to the machine. The controllers 154 include a global positioning system to provide GPS coordinates. The vision guidance system 1170 includes at least one camera and a processor. The global positioning system is in communication with the processor, and the processor is in communication with the autosteer controller. The processor is configured to modify the GPS coordinates to a modified GPS coordinates to maintain a desired travel for the self-propelled machine.

In another example, a boom actuation system 170 moves a boom arm 22 of the implement between a storage position and a deployed position, and the arm is actuated with the boom actuation system.

In one embodiment, a machine-accessible non-transitory medium (e.g., memory 105) contains executable computer program instructions which when executed by a data processing system cause the system to perform operations or methods of the present disclosure.

It will be appreciated that additional components, not shown, may also be part of the system in certain embodiments, and in certain embodiments fewer components than shown in FIG. 11 and FIG. 12 may also be used in a data processing system. It will be appreciated that one or more buses, not shown, may be used to interconnect the various components as is well known in the art.

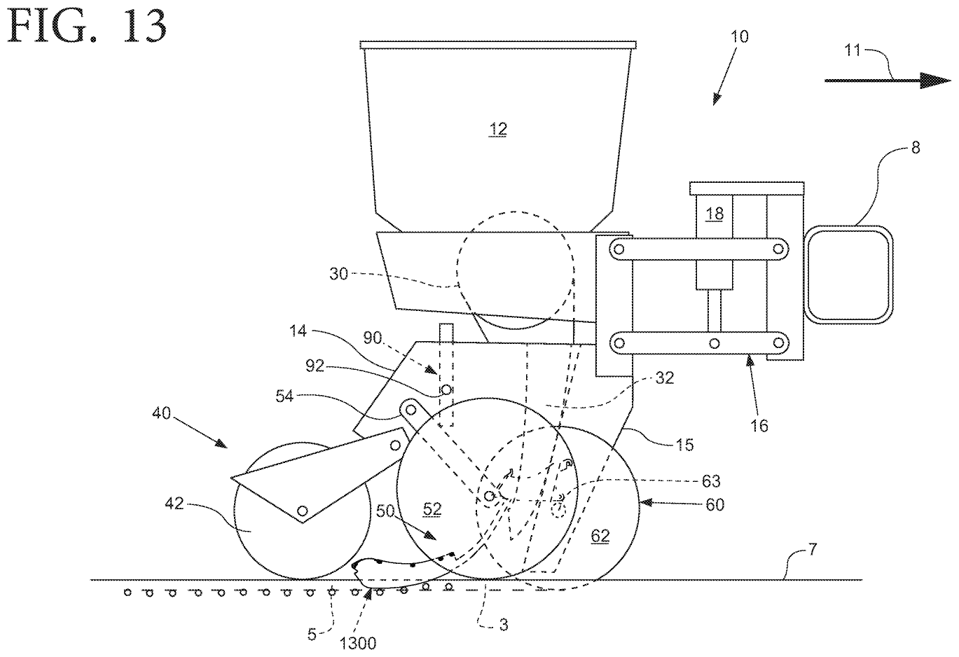

FIG. 13 is a side elevation view of a row unit 10 of an agricultural planter with a seed firmer 1300 mounted to the row unit 10. It should be understood that the planter comprises a plurality of row units 10 mounted along the toolbar 8 in spaced relation. The row units 10 are mounted to the toolbar 8 by a parallel arm linkage 16 permitting the individual row units 10 to independently translate vertically with respect to the toolbar 8. The row unit 10 is shown as incorporating an actuator 18 mounted to the toolbar 8 and the parallel arm linkage 16 to apply supplemental downpressure to the row unit 10.

The row unit 10 includes a frame 14 having a downwardly extending shank 15. The frame 14 supports an opening disc assembly 60, a gauge wheel assembly 50 and a closing assembly 40. The opening assembly 60 includes two opening discs 62 rotatable about a shaft 63 supported by the shank 15. The opening discs 62 are disposed to cut a v-shaped trench 3 in the soil surface 7 as the row unit is drawn through the field in the direction of arrow 11. The gauge wheel assembly 50 includes two gauge wheels 52 pivotally mounted to the frame 14 by gauge wheel arms 54. A depth adjustment assembly 90 adjustably positions the gauge wheels 52 with respect to the opening discs 62 by contacting the gauge wheel arms 54 to limit the upward travel of the gauge wheel arms 54, thus limiting the depth of the trench 3 opened by the opening discs 62. The closing assembly 40 may include closing wheels 42 disposed to move soil back into the trench 3 to cover the seeds previously deposited as discussed below.

Continuing to refer to FIG. 13, seeds 5 are communicated from a hopper 12 to a seed meter 30 which dispenses seeds into the seed tube 32 extending downwardly and rearwardly toward the seed trench 3 between the opening discs 62 and the gauge wheels 52. In operation, as the planter is drawn through the field in the direction of arrow 11, the seeds 5 dispensed by the meter 30 are directed downwardly and rearwardly by the seed tube 32 where they are deposited in the seed trench 3 formed by the opening discs 62. A seed firmer 1300 presses the deposited seeds 5 into the soil at the bottom of the seed trench 3 before the seeds are covered with soil by the closing assembly 40 having a closing force.

Any of the following examples can be combined into a single embodiment or these examples can be separate embodiments. The following are non-limiting examples.

Example 1 is a computer implemented method for providing a replay functionality for agricultural data layers in a field view of a graphical user interface (GUI) of a software application comprising receiving with the GUI a user input for selecting a parameter for an agricultural data layer, generating and displaying with the GUI the agricultural data layer in the field view based on the user input, receiving, with the GUI of the software application, selection of one or more locations in the field view, and generating and displaying a notification (e.g., intelligent flag to display an associated data value) for each selected location in the field view.

Example 2—The computer implemented method of Example 1, further comprising receiving, with the graphical user interface, user input to initiate a replay functionality for replaying a route of a tractor during an application pass and replaying the agricultural data layer as collected during the application pass.

Example 3—The computer implemented method of any of Examples 1-2, further comprising generating, with the graphical user interface, a video replay for the field view with a tractor icon moving across the agricultural data layer for the selected parameter based on the user input to initiate replay functionality.

Example 4—The computer implemented method of any of Examples 1-3, further comprising generating a pop up window or a side by side window to display a data value that is associated with a location of the tractor icon and the data value updates as the tractor icon moves along a route of a tractor during data collection from an application pass.

Example 5—The computer implemented method of any of Examples 1-4, wherein the pop up window or the side by side window to display one or more data values including a data value for a first parameter and a data value for a second parameter that are associated with the location of the tractor icon.

Example 6—The computer implemented method of any of Examples 1-5, wherein the pop up window or the side by side window displays diagnostics including force diagnostics for any location in the field or machine sensors readings including voltages, a meter vacuum, a duty cycle, encoder counts, or CAN network statistics from an implement bus.

Example 7—The computer implemented method of any of Examples 1-6, further comprising collecting the data values for the agricultural data layer from sensors of a tractor or implement during data collection of an application pass.

Example 8—The computer implemented method of any of Examples 1-7, wherein the parameter comprises a plant summary including coverage, elevation, or vehicle speed, a closing force parameter or a down force parameter including an applied force, an average force, a force margin, a minimum force, or a force state, an insecticide or weed & feed parameter, a nitrogen, a starter, a fungicide parameter, or a seeding parameter including a crop hybrid, a population, a population state, a seeding tank, a singulation, or a SRI.

Example 9 is a system comprising a display device for displaying a graphical user interface having a field view with data values for a parameter for an agricultural data layer for an agricultural field and a diagnostics view and at least one processor coupled to the display device. The at least one processor is configured to execution instructions to receive a user input for selecting the parameter for the agricultural data layer, to generate and display the agricultural data layer in the field view based on the user input, to receive selection of one or more locations in the field view, and to generate and display a flag to display an associated data value for each selected location in the field view.

Example 10—The system of Example 9, wherein the at least one processor is configured to execute instructions to receive user input to initiate a replay functionality for replaying a route of a tractor during an application pass.

Example 11—The system of any of Examples 9-10, wherein the at least one processor is configured to execute instructions to generate a video replay for the field view with a tractor icon moving across the agricultural data layer for the selected parameter based on the user input to initiate replay functionality.

Example 12—The system of any of Examples 9-11, wherein the at least one processor is configured to execute instructions to generate a pop up window or a side by side window to display a data value that is associated with a location of the tractor icon and the data value updates as the tractor icon moves along a route of a tractor during data collection from an application pass.

Example 13—The system of any of Examples 9-12, wherein the pop up window or the side by side window to display one or more data values including a data value for a first parameter and a data value for a second parameter that are associated with the location of the tractor icon.

Example 14—The system of any of Examples 9-13, wherein the at least one processor is configured to execute instructions to generate diagnostics for the diagnostics view including force diagnostics for any location in the field or machine sensors readings including voltages, a meter vacuum, a duty cycle, encoder counts, or CAN network statistics from an implement bus.

Example 15 is a computer implemented method for providing a viewing functionality for agricultural data layers in a field view of a user interface of a software application comprising receiving a user input for selecting a first parameter for a first agricultural data layer, generating and displaying the first agricultural data layer in the field view based on the user input, receiving, with the user interface of the software application, selection of a target point at a first location of the first agricultural data layer in the field view, and generating and displaying a first data value for the selected first location in a field based on the user input.

Example 16—The computer implemented method of Example 15, further comprising receiving user input for moving the target point to a second location of the first agricultural data layer in the field view, and generating and displaying a second data value of the first agricultural data layer for the selected second location in the field based on the user input.

Example 17—The computer implemented method of any of Examples 15-16, wherein the software application comprises a mobile software application that is displayed on a mobile device.

Example 18—The computer implemented method of any of Examples 15-17, further comprising receiving a user input to select a second parameter for a second agricultural data layer from a parameter region, generating and displaying the second agricultural data layer in a second portion of the field view based on the user input.

Example 19—The computer implemented method of any of Examples 15-18, further comprising automatically resizing the first agricultural data layer in a first portion of the field view for a split view of the first and second data layers.

Example 20—The computer implemented method of any of Examples 15-19, wherein the second portion of the field view displays the target point at the second location in the second agricultural data layer and shows a data value at this second location when the target point is positioned at second location in the field for the first agricultural data layer.

Example 21—The computer implemented method of any of Examples 15-20, further comprising receiving user input for moving the target point to a third location of the first data layer in the field view; and generating and displaying a data value in the first data layer and a data value in the second data layer for the third location in the field based on the target point being positioned at the third location.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

1. A computer implemented method for providing a replay functionality for agricultural data layers in a field view of a graphical user interface comprising:
receiving, with the graphic user interface, a user input for selecting a parameter for an agricultural data layer that was previously collected during an application pass;
generating and displaying with the graphical user interface the agricultural data layer in the field view based on the user input;
receiving, with the graphical user interface, selection of one or more locations in the field view; and
generating and displaying with the graphical user interface a notification to display an associated data value for each selected location in the field view.

2. The computer implemented method of claim 1, further comprising:
receiving, with the graphical user interface, user input to initiate a replay functionality for replaying a route of a tractor during an application pass and replaying the agricultural data layer as collected during the application pass.

3. The computer implemented method of claim 1, further comprising:
generating, with the graphical user interface, a video replay for the field view with a tractor icon moving across the agricultural data layer for the selected parameter based on the user input to initiate replay functionality.

4. The computer implemented method of claim 3, further comprising:
generating a pop up window or a side by side window to display a data value that is associated with a location of the tractor icon and the data value updates as the tractor icon moves along a route of a tractor during data collection from the application pass.

5. The computer implemented method of claim 4, wherein the pop up window or the side by side window to display one or more data values including a data value for a first parameter and a data value for a second parameter that are associated with the location of the tractor icon.

6. The computer implemented method of claim 4, wherein the pop up window or the side by side window displays diagnostics including force diagnostics for any location in an agricultural field or machine sensors readings including voltages, a meter vacuum, a duty cycle, encoder counts, or CAN network statistics from an implement bus.

7. The computer implemented method of claim 1, further comprising:
collecting the data values for the agricultural data layer from sensors of a tractor or implement during data collection of an application pass.

8. The computer implemented method of claim 1, wherein the parameter comprises a plant summary including coverage, elevation, or vehicle speed, a closing force parameter or a down force parameter including an applied force, an average force, a force margin, a minimum force, or a force state, an insecticide or weed & feed parameter, a nitrogen, a starter, a fungicide parameter, or a seeding parameter including a crop hybrid, a population, a population state, a seeding tank, a singulation, or a SRI.

9. A system comprising:
a display device for displaying a user interface having a field view with data values for a parameter for an agricultural data layer for an agricultural field and a diagnostics view; and
at least one processor coupled to the display device, the at least one processor is configured to execution instructions to receive a user input for selecting the parameter for the agricultural data layer, to generate and display the agricultural data layer in the field view based on the user input, to receive selection of one or more locations in the field view, and to generate and display a flag to display an associated data value for each selected location in the field view.

10. The system of claim 9, wherein the at least one processor is configured to execute instructions to receive user input to initiate a replay functionality for replaying a route of a tractor during an application pass.

11. The system of claim 10, wherein the at least one processor is configured to execute instructions to generate a video replay for the field view with a tractor icon moving across the agricultural data layer for the selected parameter based on the user input to initiate replay functionality.

12. The system of claim 11, wherein the at least one processor is configured to execute instructions to generate a pop up window or a side by side window to display a data value that is associated with a location of the tractor icon and the data value dynamically updates as the tractor icon moves along a route of a tractor during data collection from an application pass.

13. The system of claim 12, wherein the pop up window or the side by side window to display one or more data values including a data value for a first parameter and a data value for a second parameter that are associated with the location of the tractor icon.

14. The system of claim 9, wherein the at least one processor is configured to execute instructions to generate diagnostics for the diagnostics view including force diagnostics for any location in the field or machine sensors readings including voltages, a meter vacuum, a duty cycle, encoder counts, or CAN network statistics from an implement bus.

15. A computer implemented method for providing a viewing functionality for agricultural data layers in a field view of a graphical user interface of a software application comprising:
receiving a user input for selecting a first parameter for a first agricultural data layer that was collected by an implement during an application pass;
generating and displaying the first agricultural data layer in the field view based on the user input;
receiving, with the graphical user interface, selection of a target point at a first location of the first agricultural data layer in the field view; and
generating and displaying a first data value for the selected first location in a field based on the user input.

16. The computer implemented method of claim 15, further comprising:
receiving user input including an expand input or pan input for moving the target point to a second location of the first agricultural data layer in the field view; and
generating and displaying a second data value of the first agricultural data layer for the selected second location in the field based on the user input.

17. The computer implemented method of claim 15, wherein the software application comprises a mobile software application that is displayed on a mobile device.

18. The computer implemented method of claim 15, further comprising:
receiving a user input to select a second parameter for a second agricultural data layer from a parameter region; and
generating and displaying the second agricultural data layer in a second portion of the field view based on the user input.

19. The computer implemented method of claim 18, further comprising:
automatically resizing the first agricultural data layer in a first portion of the field view for a split view of the first and second agricultural data layers.

20. The computer implemented method of claim 19, wherein the second portion of the field view displays the target point at the second location in the second agricultural data layer and shows a data value at this second location when the target point is positioned at second location in the field for the first agricultural data layer.

21. The computer implemented method of claim 19, further comprising:
receiving user input for moving the target point to a third location of the first data layer in the field view; and
generating and displaying a data value in the first data layer and a data value in the second data layer for the third location in the field based on the target point being positioned at the third location.
